(19) United States
(12) Patent Application Publication
(10) Pub. No.: US 2020/0158488 A1
(43) Pub. Date: May 21, 2020

(54) TORSION DETECTING DEVICE FOR ROTARY SHIFT

(71) Applicant: Hiwin Mikrosystem Corp., Taichung City (TW)

(72) Inventors: Heng-Sheng HSIAO, Taichung City (TW); Zhi-Hao XU, Taichung City (TW); Chih-Mao SHIAO, Taichung City (TW)

(21) Appl. No.: 16/198,157

(22) Filed: Nov. 21, 2018

(51) Int. Cl. G01B 7/24; H04Q 9/02

(52) U.S. Cl. CPC G01B 7/24; H04Q 2209/84; H04Q 9/02

(57) ABSTRACT

A torsion detecting device for a rotary shaft is provided. The position detecting device for a rotary shaft comprises a shaft and two encoding elements disposed at two portions of the shaft with a predetermined distance. Each encoding element comprises a first coding unit, a second coding unit and a detecting unit wherein the first coding unit and the second coding unit are coaxial to the shaft. Therefore, the detecting unit detects the signal of the first coding unit and the second coding unit to retrieve the angular position of the two portions and provide the torsion in accordance with the rotation angle difference and the predetermined distance.

### BACKGROUND OF THE INVENTION

### Field of the Invention

The invention relates to a torsion detecting device, and more particularly to a torsion detecting device for a rotary shaft.

### Description of the Related Art

For industrial automation and control, the conventional rotary encoder converts the angular position or motion into the movement information (rotation distance, velocity and angle) of a rotary shaft of a tool machine or a spindle motor.

In addition to the movement information of the rotary shaft, the torsion of the shaft should be considered to prevent from the defect loss. Therefore, detecting the torsion of the shaft to enhance the processing accuracy becomes the challenge on the industrial automation and control.

### SUMMARY OF THE INVENTION

In view of the disadvantages of prior art, the object of the present invention is to provide a torsion detecting device for a rotary shaft to detect the torsion on the shaft.

To achieve the above object, the torsion detecting device for a rotary shaft comprises a shaft and two encoding elements disposed at two portions of the shaft with a predetermined distance. Each encoding element comprises a first coding unit, a second coding unit and a detecting unit wherein the first coding unit and the second coding unit are coaxial to the shaft. Therefore, the detecting unit detects the signal of the first coding unit and the second coding unit to retrieve the angular position of the two portions and provide the torsion in accordance with the rotation angle difference and the predetermined distance.

In one embodiment of the present invention, the detecting unit is disposed on an additional part and corresponds to the first coding unit and the second coding unit for detecting the signal of the first coding unit and the second coding unit.

In one embodiment of the present invention, the body is a circle formation, and the first coding unit and the second coding unit are configured on a surface of the body.

In one embodiment of the present invention, the body is an encircled plate, and the first coding unit and the second coding unit are configured on a periphery of the body.

In one embodiment of the present invention, the second coding unit comprises a plurality of annular tracks coaxial to the shaft.

In one embodiment of the present invention, the first coding unit is an absolute coding unit or an incremental coding unit.

In one embodiment of the present invention, the detecting unit is a hall sensor or a magneto-resistive sensor.

### BRIEF DESCRIPTION OF THE DRAWINGS

FIG. 1 is a schematic view of the coding unit of the first embodiment of the present invention;

FIG. 2 is a schematic view of the position detecting device for a rotary shaft of the first embodiment of the present invention;

FIG. 3 is a flow chart illustrating the determination of the torsion and rotational shift of the shaft;

FIG. 4 is a schematic view of the coding unit of the second embodiment of the present invention; and

FIG. 5 is a schematic view of the torsion detecting device for a rotary shaft of the second embodiment of the present invention.

### DETAILED DESCRIPTION OF THE PREFERRED EMBODIMENTS

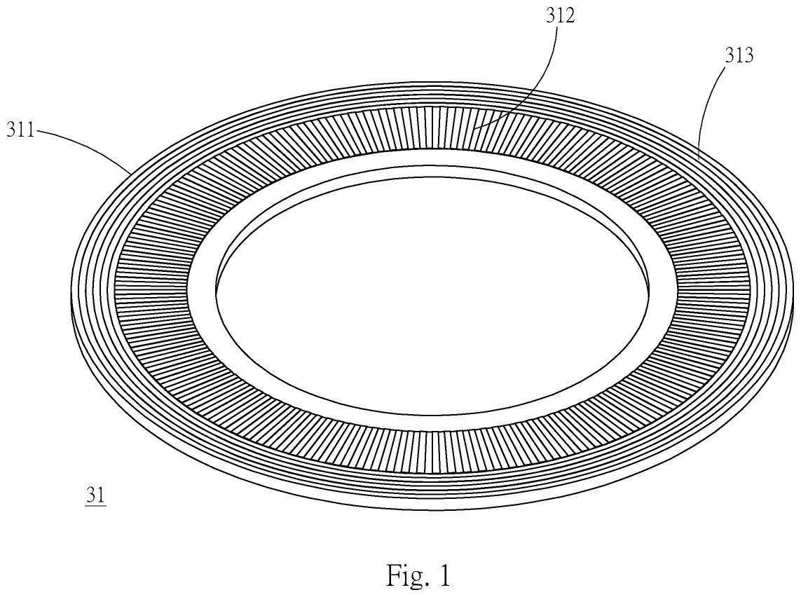

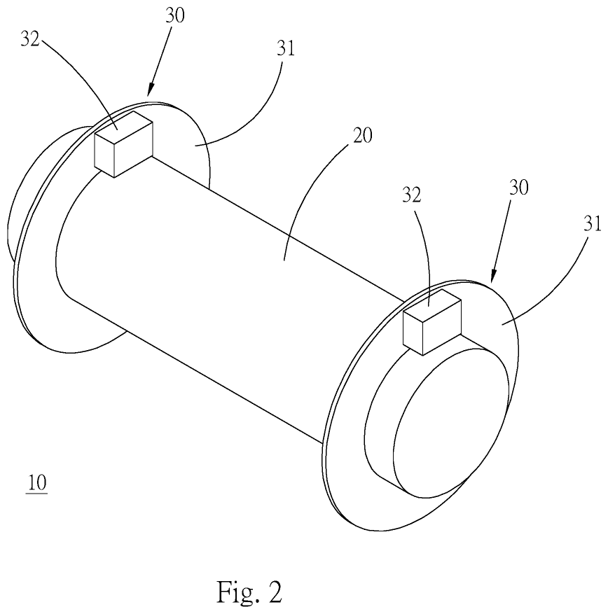

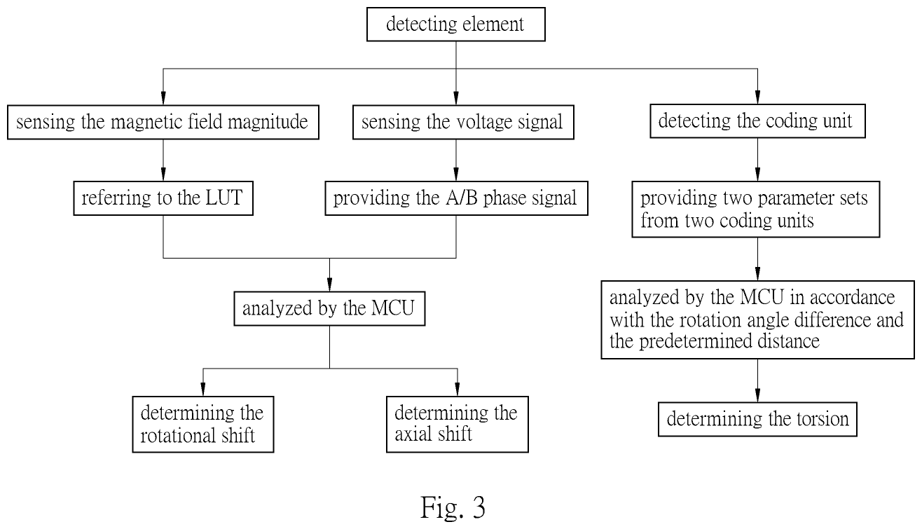

Refer to FIG. 1 to FIG. 3. The torsion detecting device for a rotary shaft 10 of the first embodiment of the present invention comprises a shaft 20 and two encoding elements 30.

The shaft 20 can be a rotary shaft of a tool machine or a spindle motor, and provided as a pillar formation. The shaft 20 belongs to the conventional technology, so there is no more detailed description herein.

The encoding elements 30 are disposed at two ends of the shaft 20 with a predetermined distance to provide two parameter sets of the rotation such that the torsion of the shaft 20 can be determined in accordance with the value difference between the rotation angles from the respective encoding element 30.

In specific, each encoding element 30 comprises a coding unit 31 and a detecting unit 32 wherein the coding unit 31 comprises a body 311, a first coding unit 312 and a second coding unit 313. The body 311 is rotatably disposed on the shaft 20 and formed as a circle plate. The first coding unit 312 and the second coding unit 313 are configured on a surface of the body 311 and coaxial to the shaft 20.

The detecting unit 32 is disposed on an additional part (not shown) and corresponds to the first coding unit 312 and the second coding unit 313 for retrieving the rotation angle and the shift distance of the shaft 20 respectively.

Furthermore, the detecting unit 32 is a hall sensor or a magneto-resistive sensor. The first coding unit 312 is an incremental coding unit in this embodiment or an absolute coding unit in other embodiment, and the technology is well-known for the people skilled in the art so there is no more detailed description herein.

Therefore, two parameter sets retrieved by the two encoding elements 30 disposed at two ends of the shaft 20 are compared to determine whether the torsion occurs on the shaft 20 or not. The torsion doesn't occur when the two parameter sets are the same. In contrary, the torsion occurs when the two parameter sets are not the same. Besides, the torsion on the shaft 20 can be analyzed in accordance with the rotation angle difference and the predetermined distance.

Moreover, the second coding unit 313 comprises a plurality of tracks configured in an annular arrangement, and the detecting unit 32 detects the annular tracks to provide the output A/B phase signals in the form of square waves wherein the amplitude of the square waves get higher as the increasing distance of the rotational shift. In other words, the amplitude of the square wave is kept in a steady situation when the shaft 20 rotates without the rotational shift and the amplitude of the square wave raises when the shaft 20 rotates with the rotational shift. Therefore, the distance of the rotational shift can be analyzed in accordance with the amplitude of the square wave.

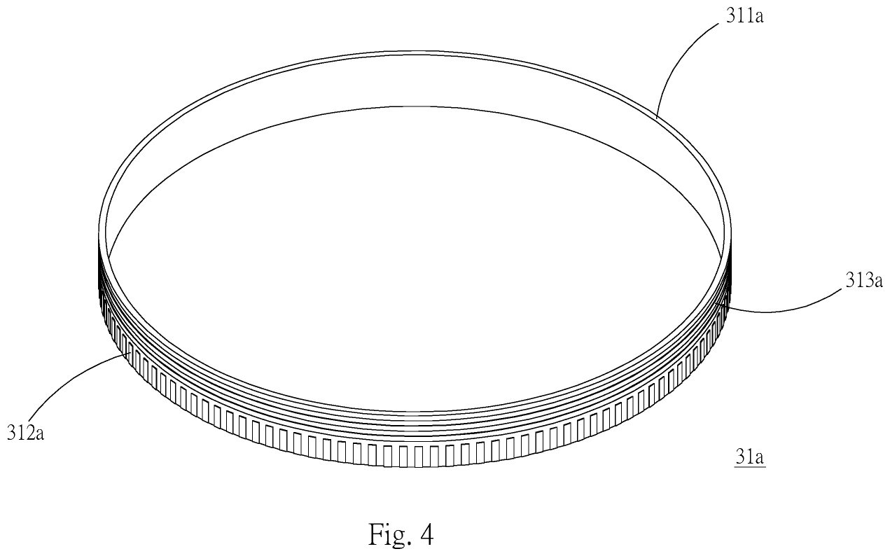

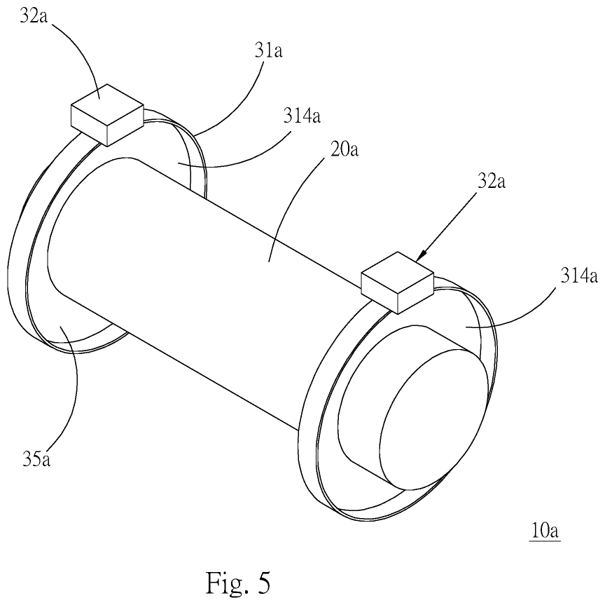

Refer to FIG. 4 and FIG. 5 which illustrates the torsion detecting device for a rotary shaft 10 of the second embodiment of the present invention. The coding unit 31a is an encircled plate disposed on the shaft 20a by a piece 314a wherein the first coding unit 312a and the second coding unit 313a are configured on a periphery of the body 311a. In this embodiment, the first coding unit 312a is an absolute coding unit. Consequently, two parameter sets retrieved by the two detecting unit 32a disposed at two ends of the shaft 20 are compared to determine whether the torsion occurs on the shaft 20 or not, and the amplitude of the square wave from the annular tracks are detected to determine whether the axial shift occurs on the shaft 20 or not.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. A torsion detecting device for a rotary shaft, comprising:
a shaft; and
two encoding elements, disposed at two portions of the shaft with a predetermined distance and comprising a first coding unit, a second coding unit and a detecting unit respectively wherein the first coding unit and the second coding unit are coaxial to the shaft;
whereby the detecting unit detects the signal of the first coding unit and the second coding unit to retrieve the angular position of the two portions and provide the torsion in accordance with the rotation angle difference and the predetermined distance.

2. The torsion detecting device for a rotary shaft as claimed in claim 1, wherein each of the encoding elements comprises a body rotatably disposed on the shaft, and the first coding unit and the second coding unit are configured on the body.

3. The torsion detecting device for a rotary shaft as claimed in claim 1, wherein the detecting unit is disposed on an additional part and corresponds to the first coding unit and the second coding unit for detecting the signal of the first coding unit and the second coding unit.

4. The torsion detecting device for a rotary shaft as claimed in claim 2, wherein the body is a circle formation, and the first coding unit and the second coding unit are configured on a surface of the body.

5. The torsion detecting device for a rotary shaft as claimed in claim 2, wherein the body is an encircled plate, and the first coding unit and the second coding unit are configured on a periphery of the body.

6. The torsion detecting device for a rotary shaft as claimed in claim 1, wherein the second coding unit comprises a plurality of tracks coaxial to the shaft.

7. The torsion detecting device for a rotary shaft as claimed in claim 6, wherein the tracks are configured in an annular arrangement.

8. The torsion detecting device for a rotary shaft as claimed in claim 1, wherein the first coding unit is an absolute coding unit.

9. The torsion detecting device for a rotary shaft as claimed in claim 1, wherein the first coding unit is an incremental coding unit.

10. The torsion detecting device for a rotary shaft as claimed in claim 1, wherein the detecting unit is a hall sensor or a magneto-resistive sensor.
